(19) United States
(12) Patent Application Publication
(10) Pub. No.: US 2001/0031099 A1
(43) Pub. Date: Oct. 18, 2001

(54) Image processing system, image sensing device, and computer program

(76) Inventors: Takashi Kondo, Sakai-Shi (JP); Kazuhiro Shibatani, Sakai-Shi (JP); Masayuki Ueyama, Takarazuka-Shi (JP); Akira Kosaka, Yao-Shi (JP); Ichiro Kasai, Kawachinagano-Shi (JP)

Correspondence Address: MCDERMOTT WILL & EMERY, 600 13TH STREET, N.W., WASHINGTON, DC, 20005-3096, US

(21) Appl. No.: 09/752,826

(22) Filed: Jan. 3, 2001

(30) Foreign Application Priority Data
Jan. 4, 2000 (JP) 2000-45

(51) Int. Cl. G06T 5/00; G06K 9/40; G06K 9/22; G06K 9/36; H04N 1/047; H04N 5/217; G06T 7/60

(52) U.S. Cl. 382/275; 382/313; 382/286; 382/291; 358/473; 382/106; 348/349; 348/241

(57) ABSTRACT

An image processing system has an image acquisition unit, a document inclination acquisition unit and a correction unit. The image acquisition unit acquires a plurality of segment images by segment image sensing on a plurality of image sensing directions of a surface of an image sensing target while an image sensing device is stationary in a fixed standard direction. The document inclination acquisition unit acquires the inclination of the surface of the image sensing target relative to the standard direction. The correction unit corrects the plurality of obtained segment images in accordance with the inclination of the surface of the image sensing target and the inclination in the image sensing direction relative to the standard direction.

### RELATED APPLICATION

This application is based on Patent Application No. 2000-000045 filed in Japan, the entire content of which is hereby incorporated by reference.

### BACKGROUND OF THE INVENTION

1. Field of the Invention

The present invention relates to an image sensing device and system for processing images sensed by the image sensing device, and a computer program for image processing, and specifically relates to art in dividing and sensing an image sensing object.

2. Description of the Related Art

Although the resolution of area sensors used in digital cameras and the like has improved rapidly in recent years, the level of resolution remains inadequate for use as a document image. Conventionally, are has been proposed for compensating for inadequate resolution and realizing higher resolution images with relative ease by divided a document image into a plurality of parts and sensing these parts, then generating a composite image by pasting the obtained segment images.

Japanese Laid-Open Patent No. 11-195104 discloses art for generating a high resolution composite image by pasting such segment images. In particular, this publication discloses a correction method for eliminating image distortion generated by dislocation of the image sensing direction (normal line direction of the image sensing plane) of the segment image from the image center when generating the composite image

FIG. 13 illustrates image distortion generated by shifting of the image sensing direction from the image center. FIG. 13(a) shows images (first image and second image) obtained when an original document is sensed by dividing in left and right halves, and FIG. 13(b) shows the image sensing condition (i.e., the relationship of the document image and the image sensing direction). At this time, the optical axis direction when sensing the first image is designated the first image sensing direction, and the optical axis direction when sensing the second image is designated the second image sensing direction. Actually, the image sensing directions are set so tat the center part overlaps to reference the correspondence point for pasting, but this is omitted (FIGS. 4 and 5 are similar).

If the image sensing direction is inclined relative to the document surface, as shown in FIG. 13(b), i.e., if the angular difference of the document surface U and the plane W in proper alignment to the image sensing plane V is [0], then a rectangular image is obtained. However, the first image sensing direction and the second image sensing direction have an angular difference between the document surface U and the plane W in proper alignment to the image sensing plane V of θ/2. Accordingly, the sensed images in these image sensing directions, i.e., the first image and the second image, are distorted images reduced in conjunction with the separation from the center as shown in FIG. 13(a).

In the art disclosed in Japanese Laid-Open Patent No. 11-195104, correction of the first and second image data is performed while considering the image sensing direction inclination of θ/2 in order to correct such image distortion. Then, a high resolution image can be generated by ultimately combining both images in a distortion free state.

Although the inclination of the image sensing direction is considered in the art disclosed in Japanese Laid-Open Patent No. 11-195104, and the generated image distortion is corrected in light of this, there is no consideration given to the inclination of the camera direction and document surface.

Normally, it is extremely difficult to properly align the document and camera because the digitals camera or the like is handheld by the operator when image sensing. Furthermore, when image sensing the content written on a whiteboard at a conference or the like, image sensing must occur at an inclination due to the positional relationship of the whiteboard and the seat of the operator. Accordingly, in practice, the document surface is often inclined relative to the camera direction, and the art disclosed in Japanese Laid-Open Patent No. 11-195104 does not provide for correction of the image distortion generated by such inclination.

On the other hand, Japanese Laid-Open Patent Application No. 10-13733 discloses art for correcting image distortion generated by the inclination between a document surface and the camera direction. This art enlarges or reduces each part so as to match the magnification of the entire screen using the image sensing magnification of the center of the image sensing screen as a standard. That is, it is possible to correct image distortion generated by inclination of the camera direction and document surface by compensating based on the image sensing magnification of the screen center.

Neither case of the prior art mentions whether in images having a mixture of influences of document inclination and image sensing direction inclination.

When the art disclosed in Japanese Laid-Open Patent Application No. 10-13733 is used to correct various segmented images, the following disadvantages arise. The disadvantages arising when the image sensing magnification of the center of the image sensing screen is used as a standard are described below using FIGS. 14 and 15.

FIG. 14 shows a segmented image before correction and its image sensing situation when a document is inclined θa relative to a camera. FIG. 14(a) shows the documents obtained when a document is divided into left and right halves for image sensing (first image and second image), and FIG. 14(b) shows the image sensing condition in this case (relationship between the document surface and image sensing direction). As in FIG. 13, the image sensing directions of the first image and the second image are designated the first image sensing direction and second image sensing direction, respectively.

In FIG. 14(b), arrow A represents the direction in which the camera is pointing (camera front). The document surface U has an inclination of θa relative to the camera (i.e., relative to a plane perpendicular to the camera pointing direction. Below the angle formed by the document surface U and a plane perpendicular to the camera pointing direction is referred to as the “document inclination angle.” Consider the case wherein θa=θ/2.

The second image sensing direction has no inclination relative to the document surface U (i.e., the angular difference between the document surface U and the plane W in proper alignment to the image sensing plane V is [0]). Accordingly, the image sensed under these conditions is a rectangular image without distortion (second image) as indicated on the right side of FIG. 14(a).

Conversely, the first image sensing direction has an inclination of θ(θ=θ/2+θa) relative to the document surface U, as shown in FIG. 14(b). This situation considers the document inclination angle θa in addition to the inclination θ/2 relative to the camera pointing direction of the image sensing direction (arrow A) (hereinafter referred to as “image sensing direction inclination angle”).

As shown in FIG. 14(a), the first image becomes a distorted image due to reduction in conjunction with the separation from the center, more severely than the first image of FIG. 13(a).

FIG. 15 shows the case wherein each image sensed under the image sensing conditions of FIG. 14 is corrected using the art disclosed in Japanese Laid-Open Patent Application No. 10-13733. FIG. 15(a) shows the sensed image before correction as in FIG. 14(a), and FIG. 15(b) shows the sensed image after correction. According to the art disclosed in Japanese Laid-Open Patent Application No. 10-13733, correction is accomplished by matching the magnification of the screen center. Accordingly, when using this method to correct each segmented image of the example, the first image has a standard magnification LL, and the second image has a standard magnification LR. The corrected images have different magnifications on the left and right side as shown in FIG. 15(b), due to the difference in magnifications LL and LR. Accordingly, when these segmented images are pasted together, they cannot match.

When the camera and document are inclined, the magnification of the centers of the plurality of sensed segmented images is different, such that the magnification of the corrected images also differ, with the disadvantageous result that a suitable image cannot be obtained.

### SUMMARY OF THE INVENTION

An object of the present invention is to eliminate the previously described disadvantages.

Another object of the present invention is to suitably correct each segment image when a sensing each segment of a target image.

A further object of the present invention is to produce a frontal image of a flat target image by compensating for the inclination between a flat target image and the image sensing device.

These and other objects are attained by an image processing system comprising: an image acquisition unit for acquiring a plurality of segment images by segment image sensing on a plurality of image sensing directions of a surface comprising the image sensing target when the image sensing device is stationary in a fixed standard direction; a document inclination acquisition unit for acquiring the inclination of a surface comprising the image sensing target relative to the standard direction; and a correction unit for correcting the plurality of obtained segment images in accordance with the inclination of the surface of the image sensing target and the inclination in the image sensing direction relative to the standard direction.

These and other objects are attained by an image processing system comprising: an image acquisition unit for acquiring a plurality of segment images when sensing segments of an image sensing target surface by an image sensing device; a document inclination acquisition unit for acquiring the inclination of a surface comprising the image sensing target relative to the standard direction of the image sensing device; and a correction unit for eliminating distortion in the acquired segment images based on identical references and considering the inclination of the surface of the image sensing target.

These and other objects are attained by an image processing system comprising: an image acquisition unit for acquiring a plurality of segment images by segment sensing the surface of the target image by an image sensing device; a document inclination acquisition unit for acquiring the inclination of a surface comprising the image sensing target relative to the standard direction of the image sensing device; and a correction unit for eliminating distortion in the acquired segment images so as to have the ratio of the size of the corrected segment image equal to the size of the surface of the segment sensed image sensing target and considering the inclination of the surface of the image sensing target.

These objects of the present invention are further attained by an image sensing device comprising: an image sensing unit for segment sensing of an image sensing target by the image sensing device; a mode selector for selecting one mode from among a plurality of modes including a first mode for sensing a flat surface; a multipoint measuring unit for measuring the distance to the image sensing target at a plurality of points; a determination unit for determining whether or not an image sensing target is a flat surface based on the measurement results of the multipoint measuring unit; and a calculation unit for calculating the inclination of the image sensing target based on the measurement result of the multipoint measuring unit when the first mode is selected, and the image sensing target is a flat surface.

These objects of the present invention are further attained by a computer program executed by a computer and comprising: the acquisition of a plurality of segment images when segment image sensing of an image sensing target in a plurality of image sensing directions by the image sensing device; acquisition of the inclination of the surface of the image sensing target relative to the standard direction of the image sensing device; and elimination of the distortion of the acquired segment images in accordance with the acquired inclination of the surface of the image sensing target and the inclination of the image sensing direction relative to the standard direction.

The invention itself, together with further objects and attendant advantages, will be best understood by reference to the following detailed description taken in conjunction with the accompanying drawings.

### BRIEF DESCRIPTION OF THE DRAWINGS

FIG. 1 is a perspective view briefly showing a digital camera 10 of an embodiment of the present invention;

FIG. 2 is a perspective view showing details of an image sensing unit 15 and a scan drive unit 16;

FIG. 3 is a control block diagram showing the general structure of the digital camera 10;

FIG. 4 shows an image sensed when the total image sensing grange is divided into left and right halves (first image and second image);

FIG. 5 illustrates the positional relationship between the solid state image sensing element (CCD) 22 and the document when sensing the first image shown in FIG. 4;

FIG. 6 is a flow chart showing the main control flow of the digital camera 10;

FIG. 7 illustrates the multipoint measuring method when the image sensing range A is divided in to left and right halves;

FIG. 8 is a flow chart showing the subroutine of the image sensing process (step S612) of FIG. 6;

FIG. 9 is a flow chart showing the subroutine of the inclination correction process (step S806) of FIG. 8;

FIG. 10 shows an example of the present invention used when the total image sensing range is divided into four segments;

FIG. 11 illustrates and example of the present invention used when the total image sensing range is divided into four segments in a row;

FIG. 12 illustrates segment image sensing by a plurality of solid state image sensing elements having the same image sensing direction;

FIG. 13 shows the correction of image distortion generated by the image sensing direction shifting from the screen center;

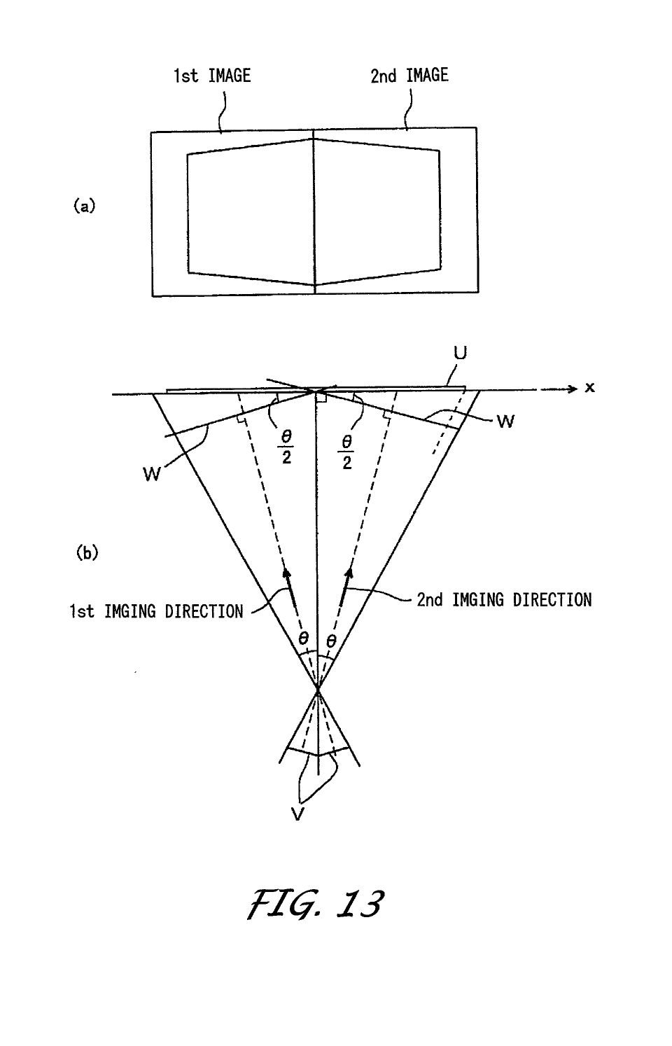

FIG. 14 illustrates the segment images before correction and the image sensing condition when a document is sensed at an inclination θa relative to the camera; and

FIG. 15 illustrates correction of a sensed image under the same conditions as FIG. 14 using the prior art.

In the following description, like parts are designated by like reference numbers throughout the several drawings.

### DESCRIPTION OF THE PREFERRED EMBODIMENTS

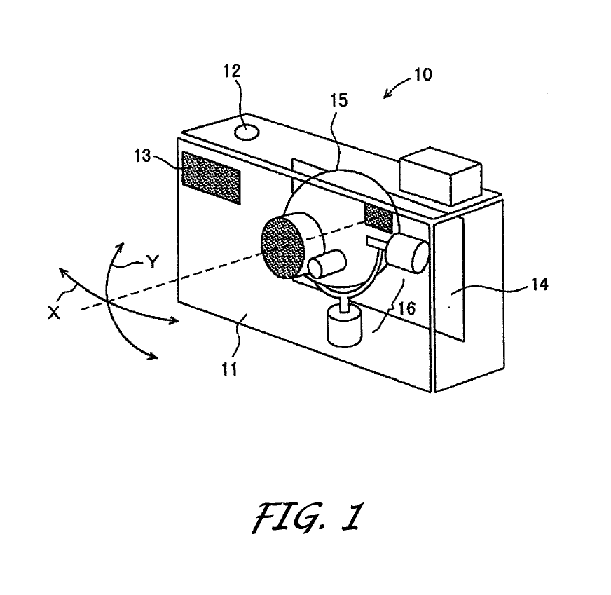

The embodiments of the present invention are described hereinafter with reference to the accompanying drawings. FIG. 1 is a perspective view briefly showing a digital camera 10 of an embodiment of the present invention. Referring to FIG. 1, the digital camera 10 is provided with a release switch 12 for starting image sensing by user operation, a multipoint measuring unit 13 for measuring the distance to an object positioned in the approximate center of the segment sensing region, display unit 14 provided on the back side of the camera body 11, image sensing unit 15 modeled on an eye, and scan drive unit 16 for scanning the image sensing unit 15.

The display unit 14 includes a liquid crystal panel, and is capable of displaying a warnign display and the sensed image. On the back side of the camera body 11 are provided, in addition to the display 14, a mode switch for switching between text and landscape modes, power switch and the like not shown in the drawings.

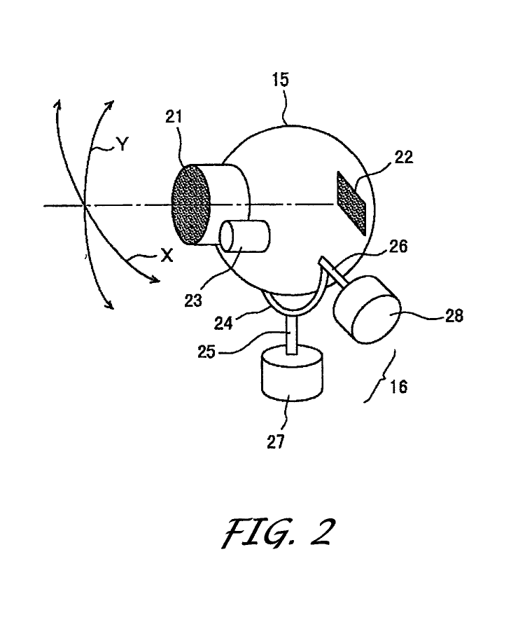

FIG. 2 is a perspective view showing details of the image sensing unit 15 and the scan drive unit 16. Referring to FIG. 2, the image sensing unit 15 is provided with a zoom lens 21 for changing the image sensing magnification of an object, zoom motor 23 for driving the zoom lens 21, and a solid state image sensing element (CCD) 22 for converting the optical signals of the object to electrical signals.

The zoom lens 21 is capable of changing the image sensing magnification by means of the drive of the zoom motor 23, and the light impinging the object forms and image on the image sensing element 22. The image sensing magnification is provided with a range capable of forming an image on the image sensing element 22 from the total image of the image sensing range to each region of segment image in accordance with the number of segments of the image sensing region.

The scan drive unit 16 comprises a U-shaped guide 24, rotating shaft 25 supporting the bottom part of the U-shaped guide 24 so as to be freely rotatable, rotating shaft 26 supporting the image sensing unit 15 so as to be freely rotatable, and motor 27 and angle sensor 28 engaging the rotating shafts 25 and 26. Fro this reason the image sensing direction of the image sensing unit 15 can be optionally controlled in the X and Y directions.

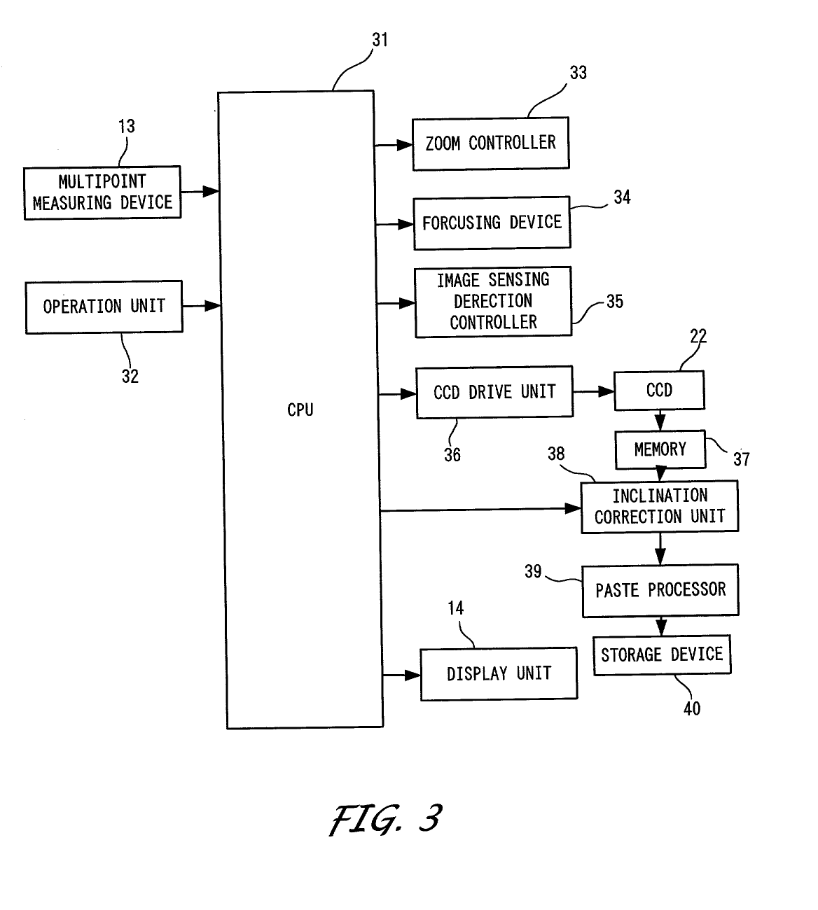

FIG. 3 is a control block diagram showing the general structure of the digital camera 10. Referring to FIG. 3, the digital camera 10 is provided with a CPU 31 for controlling the entire device, multipoint measuring device 13, operation unit 32 for accomplishing various user-performed operations, display unit 14 for displaying a preview image of the sensed image, zoom controller 33 for controlling the drive of the zoom motor 23 to change the image sensing magnification, focusing device 34 for adjusting the focus, and image sensing direction controller 35 for controlling the image sensing direction by driving the scan drive unit 16.

The operation unit 32 includes a release switch 12, power switch, and mode switch and the like.

The digital camera 10 is further provided with a CCD 22 as an image sensing element, CCD drive unit 36 for driving the CCD, memory 37 for storing image data captured by the CCD 22, inclination correction unit 38 for correcting inclination in image data stored in the memory 37, paste processor 39 for pasting segment image data after inclination correction, and storage device 40 for recording the composite image after pasting is accomplished by the paste processor 39.

The inclination correction unit 38 determines the inclination of the document surface (object surface) based on the distance of a plurality of points measured by the multipoint measuring device 13. Then, the sensed segment image data are corrected for inclination in accordance with the determined document surface inclination and the inclination in the image sensing direction set beforehand in accordance with the number of segments to be sensed.

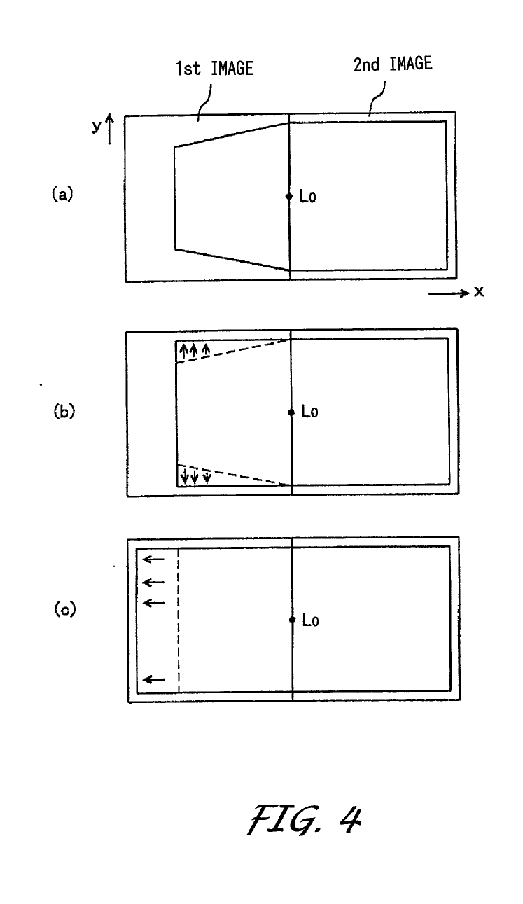

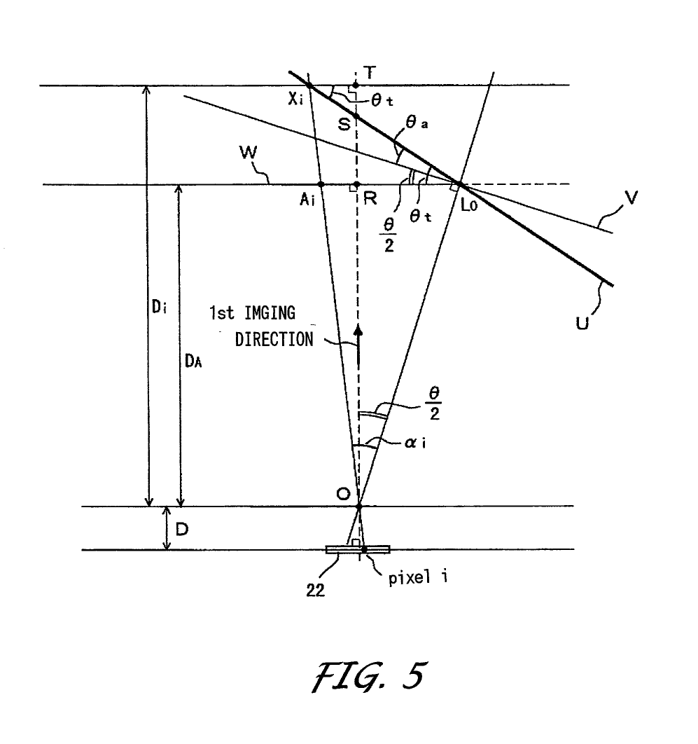

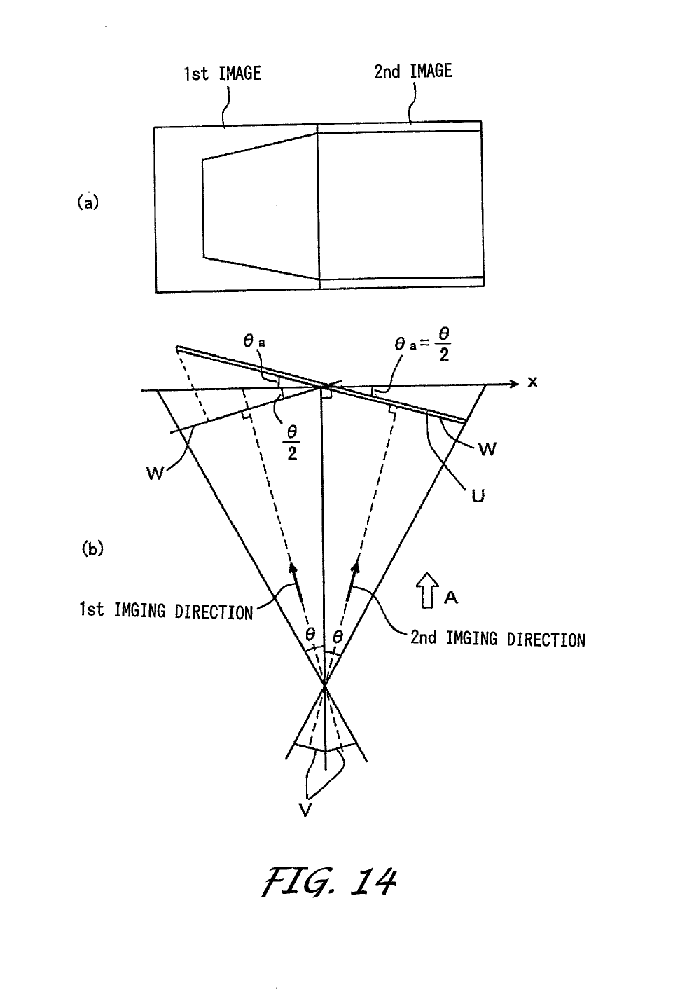

The specific correction method used in the inclination correction unit 38 is described below with reference to FIGS. 4 and 5. FIG. 4 shows the sensed images (first image and second image) when the total image sensing range is divided into left and right halves. In the drawing, L0 represents the standard point on the image used for inclination correction. The image sensing conditions are identical to the conditions described in FIG. 14.

Accordingly, the image sensing conditions for the second image have the CCD 22 surface and the document surface in proper alignment, whereas the image sensing conditions of the first image have a document inclination angle of θa and an inclination angle of θ/2 in the image sensing direction. That is, the document surface is inclined at an angle θa relative to the camera direction, and the image sensing direction is inclined at an angle θ/2. For this reason no distortion appears in the second image as shown in FIG. 4(a), but severe distortion appears in the first mage similar to that shown in FIG. 14(a).

FIG. 4(b) shows the image of FIG. 4(a) corrected by enlargement in the y direction using the magnification of L0 as a standard, and FIG. 4(c) shows the image of FIG. 4(b) corrected by enlargement in the x direction using the magnification of L0 as standard.

FIG. 5 illustrates the positional relationship between the image sensing element (CCD) 22 and the document surface when sensing the first image shown in FIG. 4. In this case the first image sensing direction matches the vertical direction (OR direction) of the drawing surface. The camera pointing direction is the slightly inclined OLo direction. As described above, the document inclination angle is θa (i.e., the angle formed by the document surface U and the plane V properly aligned with the digital camera 10 is angle θa), and the image sensing direction inclination angle is θ/2 (i.e., the angle formed by the camera pointing direction OLo and the first image sensing direction OR is angle θ/2).

Refer to the drawing and consider the case wherein correcting an inclination of an optional pixel i obtained in the CCD 22 surface.

The pixel i is the pixel at which the optical image Xi on the document surface u forms an image on the CCD 22, and must be a pixel on which is formed the image Xi of the image Ai on the plane W which is properly aligned with the CCD 22 surface through L0. Accordingly, first, the magnification at pixel i must be increased from the magnification D/Di relative to image Xi to magnification D/DA at the position of Ai. In this case the magnification ratio βi is Di/DA (where D/Di×βi=D/DA).

When the angle formed by the camera pointing direction OLo and the position direction of the image Xi on the document surface U (i.e., direction OXi) is designated angle αi, then Di can be represented as Di=DA+Di·tan(αi−θ/2)·tan(θt)+DA·tan(θ/2·tan(θt) (where Di=DA+TS+SR, TS=TXi·tan(θt), SR=RL0·tan(θt)). Accordingly, the enlargement ratio βi can be represented by equation (1) below.

βi=Di/DA={1+tan(θ/2)·tan(θt)}/{1−tan(αi−θ/2)·tan(θt)} (1)

θt is the sum of the image sensing direction inclination angle θ/2 and the document inclination angle θa (θt=θ/2+θa).

Using the enlargement ratio βi, first, the enlargement correction in the y direction shown in FIG. 4(b) is accomplished. The process disclosed in Japanese Laid-Open Patent Application No. 10-13733 is performed to replace the pixel data of the sensed image (before correction) with the pixel data of the sensed image when sensing the image of the original document enlarged at magnification βi.

With regard to the x direction, the product of the enlarge ratio βi and the correction coefficient (θt) considering influences (document inclination), i.e., βi′=βi/cos(θt), is used as the enlargement coefficient. The enlargement correction in the x direction shown in FIG. 4(c) is accomplished using the same method.

Although unrelated to the present example, when the inclination of the document U is conversely corrected by reduction, the reduction ratio can be determined using the same logic as the enlargement ratio.

Using the enlargement ratio βi (or βi′) represented by equation (1) as described above, the input image can be enlarged and corrected considering the inclination of the document surface as well as the inclination of the camera pointing direction in the image sensing direction.

Since the same point L0 is the standard for both the first image and the second image in the enlargement correction (inclination correction), both corrected images have the same magnification. Accordingly, these images can be easily pasted to produce a composite image.

With regard to the second image, since the sum θt of the image sensing direction inclination angle (−θ/2) and the document inclination angle (θa=θ/2) is [0], the y direction enlargement ratio pi and the x direction enlargement ratio βi′ are unity [1], and there is no change in the image before and after correction.

Although the current example describes the case wherein the second image sensing direction is properly aligned with the document for the purpose of the description, normally, correction of the second image is not required.

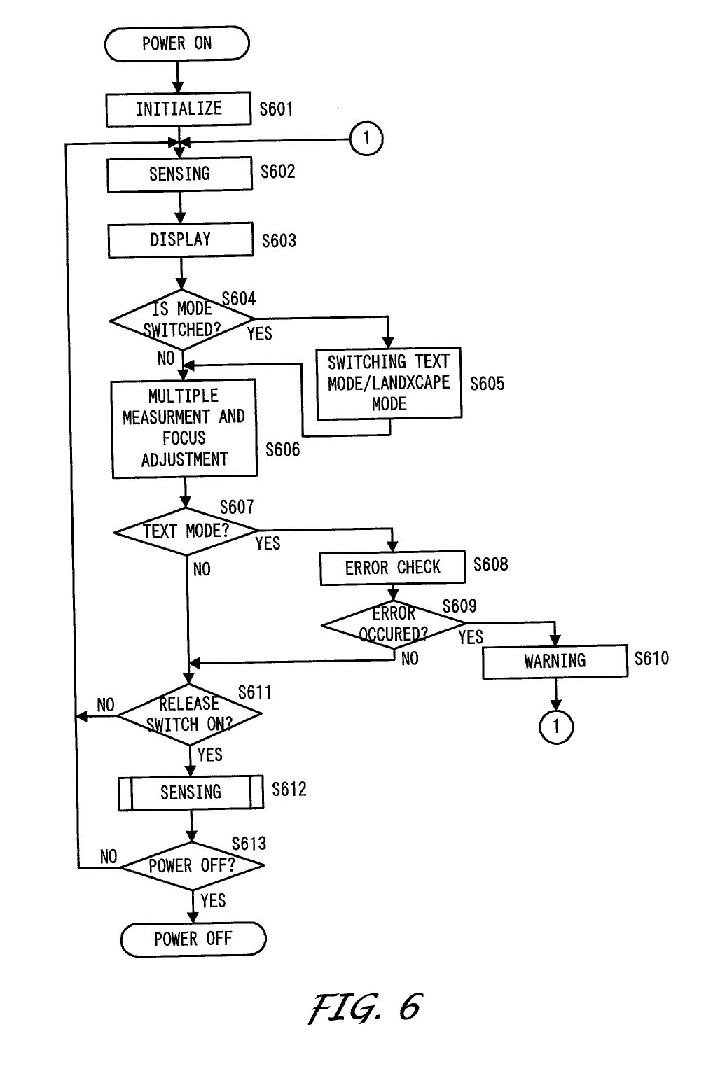

The processing flow when image sensing using the digital camera shown in FIG. 3 is described below. FIG. 6 is a flow chart showing the main control flow of the digital camera 10.

Referring to FIG. 6, when the power of the operation unit 32 is turned ON by the user, first, in step S601, each element of the digital camera 10 is initialized. At this time, the zoom is set to wide by the zoom controller 33, and the image sensing direction is set to center by the image sensing direction controller 35.

Then, in step S602, image sensing is executed with the zoom set wide. Accordingly, first, the entire image sensing range is sensed. A preview of the entire sensed image is displayed in step S603.

Then, when the mode selection switch in the operation unit 12 is pressed by the user, the mode is switched between text mode and landscape mode in step S605. When the mode selection switch is not operated, the process of step S606 is directly executed.

In step S606, multipoint measurement to the object position is executed by the multipoint measuring device 13, and focus adjustment is executed by the focus adjusting device 34. At this point in time, focus is adjusted relative to the center of the entire image sensing screen.

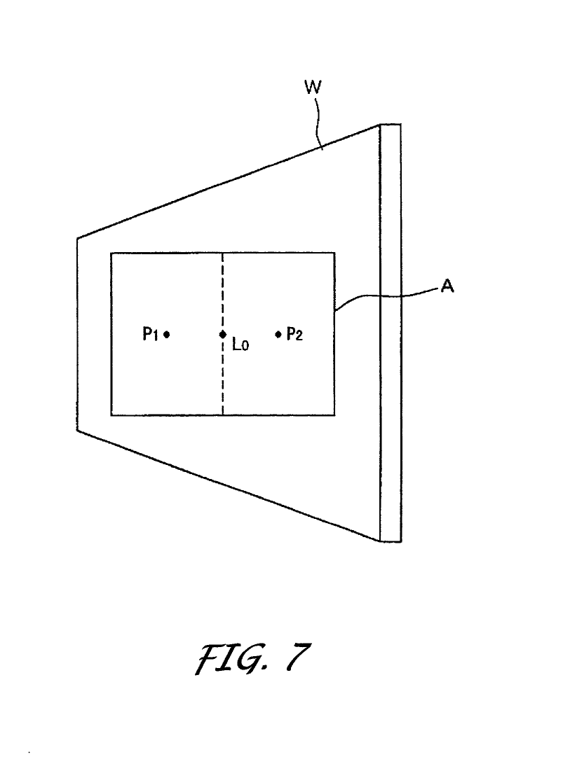

The multipoint measurement selects measurement points as described below. FIG. 7 illustrates the multipoint measurement method when sensing the image sensing range A divided into left and right halves. Assume image sensing from an inclined side relative to the whiteboard W. The image sensing range A is a suitable range selected on the whiteboard W.

The distance of three points is measured by the multipoint measuring device 13, these three points are point L0 on the whiteboard W at a position in the approximate center of the total image sensing range A, and points P1 and P2 on the whiteboard W at positions within each segment of the image sensing range.

After the multipoint measurement is accomplished in step S606, when the mode at the current time is the text mode (step S607: YES), an error check is executed in step S608 to check the flatness of the object. That is, a determination is made as to whether or not the object is flat based on the measurement result in step S606.

When the object is determined to not be flat in step S609, a warning is displayed on the display 14 in step S610, and the routine returns to the process of step S602. In the present embodiment, the release switch 12 cannot operate when an error occurs.

If an error does not occur in step S609 and the text mode has not been set in step S607, the routine advances to step S611, and a check is made to determine whether or not the release switch 12 is ON. When the release switch 12 is ON, the image sensing process is executed in step S612, whereas if the release switch 12 is OFF, the routine returns to the process of step S602.

When the image sensing process of step S612 ends and the power is turned OFF (step S613: YES), image sensing by the digital camera 10 ends. On the other hand, when the power is not turned OFF even after the image sensing process ends (step S613: NO), the routine returns to step S602 and repeats the aforesaid process to again execute image sensing.

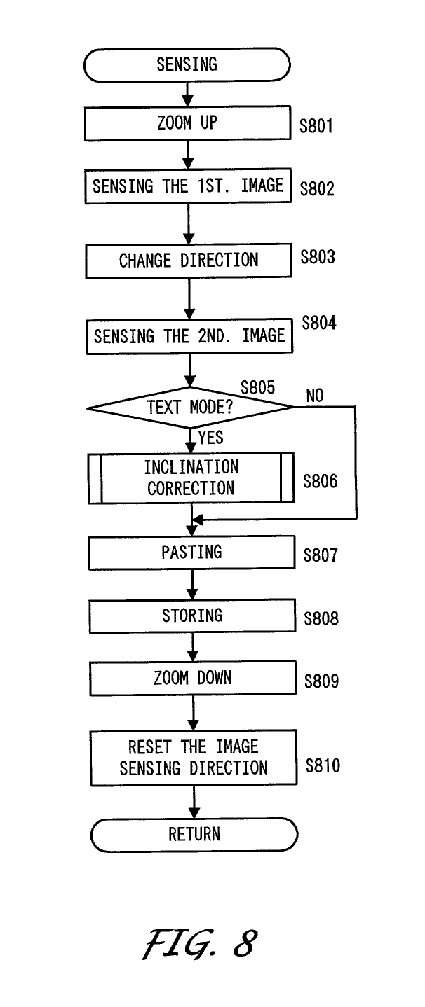

FIG. 8 is a flow chart showing the subroutine of the image sensing process (step S612) of FIG. 6. Referring to FIG. 8, first, in step S801, zoom up is executed by the zoom controller 33 so as to match the first image to the image sensing range. In this state, in step S802, the first image is sensed. Then, in step S803, the image sensing direction is changed by the image sensing direction controller 35. In step S804, the second image is sensed.

Next, in step S805, a determination is made as to whether or not the current image sensing mode is the text mode. If the current mode is determined to be the text mode, in step S806 the inclination correction process is executed. However, if the current mode is not the text mode, i.e., when the current mode is the landscape mode, the inclination correction is unnecessary and the process of step S806 is skipped.

In step S807, the segment image pasting process is executed by the pasting processor 39. When the text mode is set, the segment images are pasted after inclination correction, and when the photographic mode is set, the uncorrected segment images are pasted. The composite image resulting from the pasting process is stored in storage device 40 in step S808.

Thereafter, the zoom and image sensing direction return to the initial positions, and in step S809 zoom down is executed by the zoom controller 33, and in step S810 the image sensing direction is returned to the center direction by the image sensing direction controller 35. Then, the subroutine ends and returns to the main routine of FIG. 6.

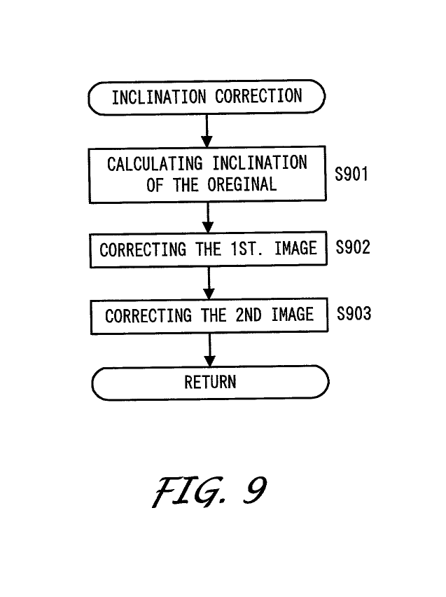

FIG. 9 is a flow chart showing the subroutine of the correction process (step S806) of FIG. 8. Referring to FIG. 9, first, in step S901, the document inclination, i.e., the document inclination angle θa in FIG. 5, is calculated. This calculation uses the multipoint measurement result obtained in step S606.

In step S902, the first image (firs image screen) is corrected, and in step S903 the second image (second image screen) is corrected. That is, a suitable enlargement process or reduction process is executed using the enlargement ratio βi or βi′ described previously in regard to FIGS. 4 and 5.

Specifically, the document inclination θa calculated in step S901 and the image sensing direction value (θ/2) controlled by the image sensing direction controller 35 when segment sensing are used to calculate the enlargement ratio βi (or reduction ratio) of each pixel, and this enlargement ratio βi is used for pixel placement considering a suitable density level.

Then, when the first image correction and the second image correction are completed, the subroutine ends, and the routine moves to the pasting process (step S807) of FIG. 8.

According to the present embodiment as described above, when correcting the segment images, consideration is given to not only the image sensing direction inclination (θ/2), but also the sensing target surface inclination (θa) relative to the digital camera 10. For this reason each segment image is subjected to a suitable variable magnification process.

Since the magnification, p[particularly when performing a variable magnification process, is calculated based on the same standard point L], the corrected segment images have the same magnification. Accordingly, these segment images can thereafter easily be pasted together so as to ultimately realize a high resolution image which is free of distortion.

### MODIFICAITONS

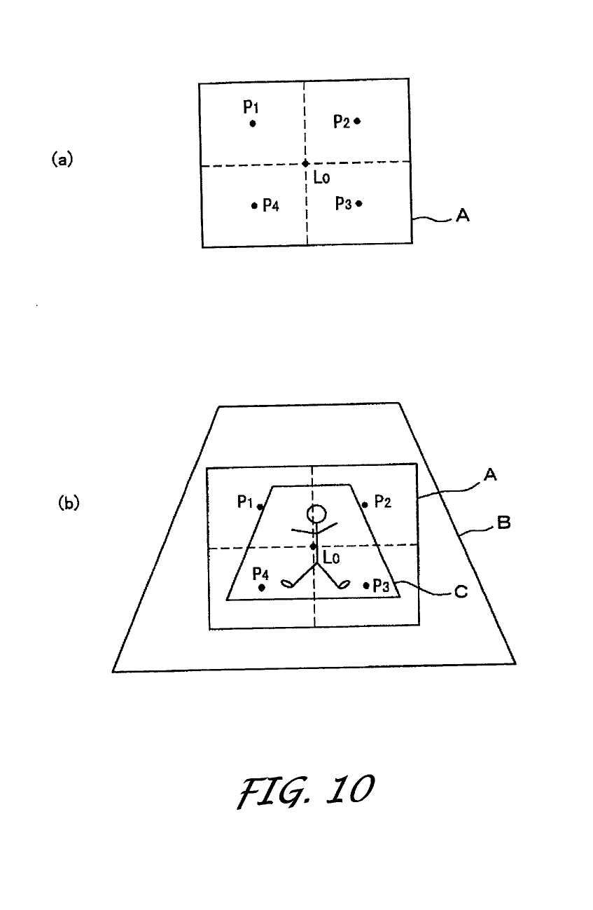

Modifications of the digital camera 10 of the aforesaid embodiment of the invention are described below. FIG. 10 shows an example of the present invention applied to a total image sensing range divided into four segments. In this modification, the total image sensing range A is divided into four segments as shown in FIG. 10(a), and each segment image is subjected to inclination correction using the same methods as described above, then the segment images are pasted together.

In this case, the measurement points when executing the multipoint measurement are the point L0 position at the approximate center of the total image sensing range A, and points P1, P2, P3, P4 positioned at the approximate center of each segment range. For example, when image sensing a document C placed on a document table B as shown in FIG. 10(b), the distance is measured to point L0 on document C or document table B, and points P1˜P4. Then, the inclination θa of the object (document surface) relative to the camera is calculated based on the measurement result.

The magnification o these segment images is corrected based on the magnification at the same standard point L0. Accordingly, the four segment images have the same magnifications as the sensed images, and are easily pasted together.

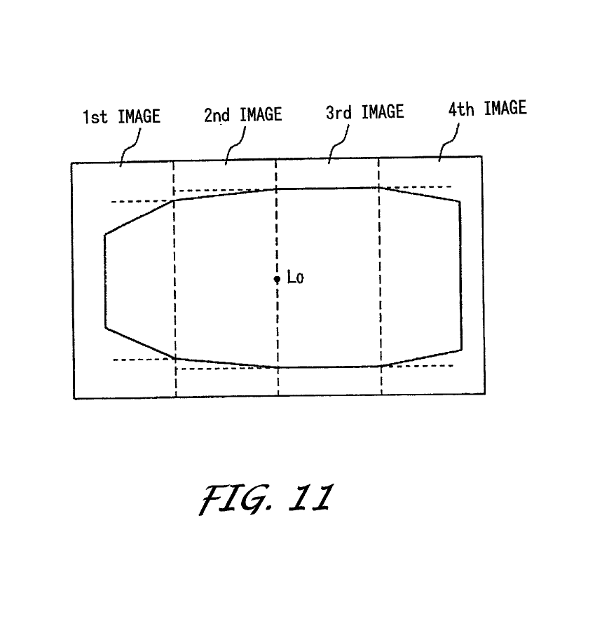

The present invention also may be applied when the total image sensing range is divided into four segment in a row, as shown in FIG. 11. In this case, the first image through fourth image may be corrected using the point L0 at the approximate center of the total sensing ranges a standard. In this way all images are corrected to the same magnification.

In FIGS. 4, 10, and 11, the reference position when correcting is the standard point L0 at the approximate center of the total image sensing range for ease of calculation, but the present invention is not limited to this arrangement. Accordingly, an optional position may be used as the standard position.

In FIGS. 1 and 2, the image sensing element 22 and zoom lens 21 are integrated to comprise the image sensing unit 15, such that the entire body is integrated and rotated to change the image sensing direction. However, the present invention is not limited to this method, inasmuch as, for example, a rotating mirror may be provided in the image forming optical path to change the image sensing direction without moving the image sensing element 22.

Furthermore, a plurality of stationary image sensing elements may be provided beforehand so as to accomplish segment image sensing in different directions (or the same direction) without changing the image sensing direction.

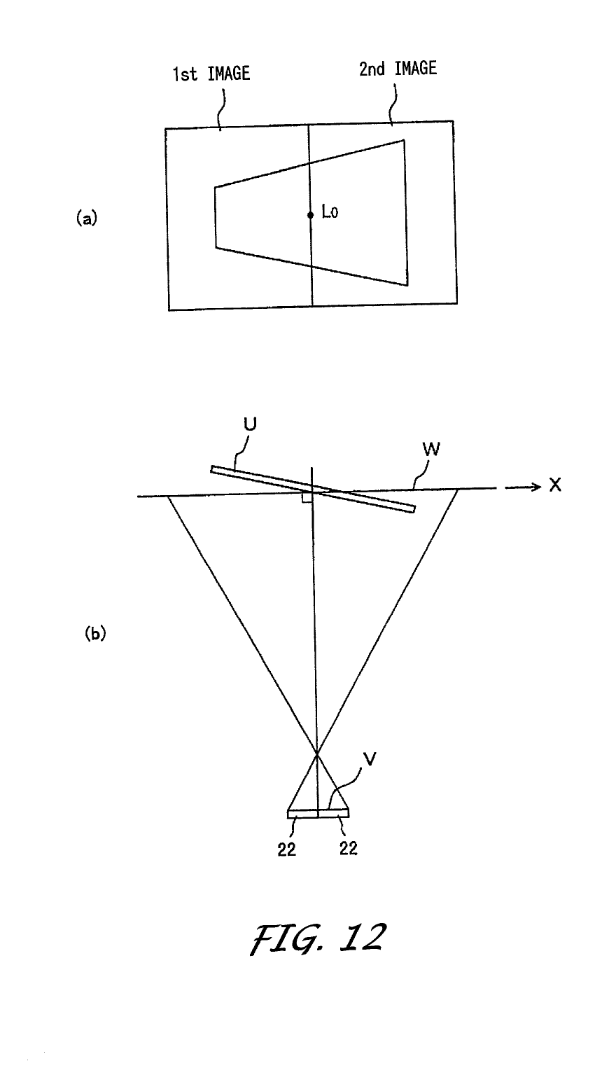

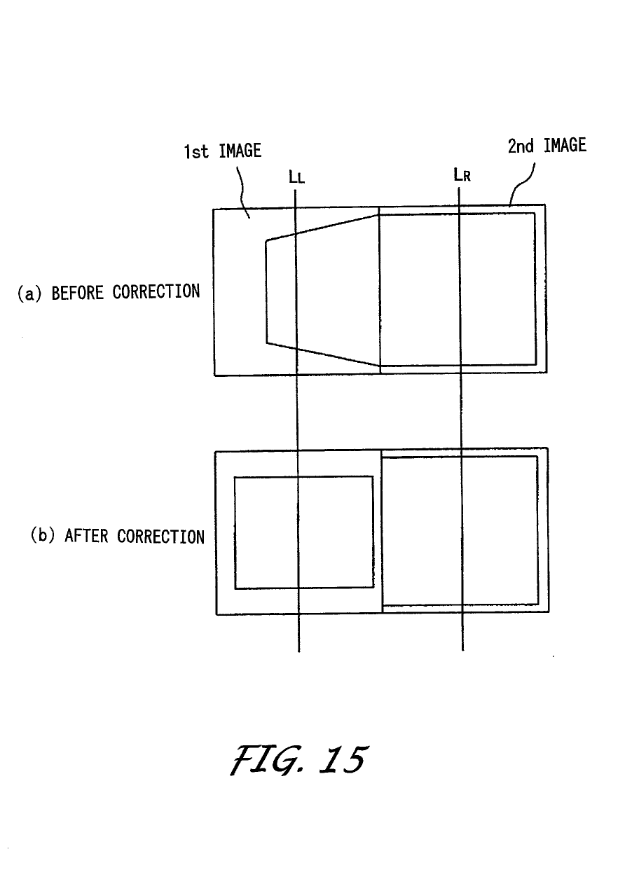

The problem of unmatched magnifications described in FIG. 15 arises when performing segment image sensing using a plurality of image sensing elements in the same image sensing direction as shown in FIG. 12. FIG. 12(a) shows the image (first image and second image) obtained before correction when a document is divided into left and right halves by two image sensing elements 22 in the same image sensing direction, and FIG. 12(b) shows this image sensing state (relationship between the document surface U and the image sensing direction).

Even when the image sensing unit has this construction, the same magnification is obtained even with left and right shifting if the inclination correction of the segment images is performed using the common point L0 as a standard, and the segment images are easily pasted together.

In FIG. 12, the image sensing element s 22 are lined up, but actually the optical path is divided by a prism or semitransparent mirror, and the elements may be arranged at different locations. These image sensing elements may be arranged so that the pasted parts overlap.

A single image sensing element moving horizontally may be used instead of a plurality of image sensing elements, and the light receiving optical system may be moved horizontally to form images of different areas on a single image sensing element.

In the present embodiment, the zoom function is used only when preview image sensing (FIG. 8, step S602), and when segment image sensing (FIG. 6, step S612), but also may be used at other times. That is, the image sensing range may be changed manually, and the zoom function may be used at that time. Since the image sensing direction may be changed in accordance with the zoom, the image sensing direction inclination angle θ/s used for inclination correction may also be suitably changed.

Although the image sensing target (document surface) inclination θa is determine by the measurement result of the multipoint measuring device 13, the measurement point i snot limited to the positions described previously. Furthermore, the inclination of the document surface may be input by another method such as a manual method without using the multipoint measuring device 13.

The segment pattern of the image sensing range is not limited to the two segments, or four segments shown in FIGS. 7, 10, and 11, inasmuch as other segment patterns also may be used. When image sensing is possible using a plurality of segment patterns in a single camera, the values of θ used in the image sensing direction inclination angle in accordance with the segment patterns may be preserved beforehand, and read out as needed. The inclination angle may be detected by an angle sensor or the like.

Although an inclination correction unit 38, paste processor 39, and storage device 40 are provided within the digital camera 10, and all processing performed by these devices occurs within the digital camera 10 in the aforesaid embodiments, the present invention is not limited to this arrangement. Accordingly, all or part of the processing may be executed by a personal computer.

For example, if processing up to the inclination correction of the segment images is performed within the digital camera, then the pasting process may be performed later by a personal computer. When the segment images are sensed, the segment image data and data required for inclination correction (e.g., image sensing direction inclination angle θ, document surface inclination angle θa and the like) may be input to a personal computer, and the inclination correction and pasting process may be performed by software in the personal computer. In this case the software is stored on a storage medium, and is read and executed by the personal computer.

In the description of FIGS. 4 and 5, the enlargement process (or reduction process) used the method disclosed in Japanese Laid-Open Patent Application No. 10-13733, but the present invention is not limited to this method. Accordingly, enlargement correction may be accomplished by, for example, the so-called image dilution method, and the reception correction may be accomplished by the so-called pixel culling method.

Although the form of the portable digital camera has been described by way of examples in the aforesaid embodiments, the present invention is not limited to these examples inasmuch as the present invention may be adapted to a desktop scanner which having a image sensing unit fixed on a stand to sense a document from above.

In the case of a desktop scanner, the scanner may be properly aligned with the document by the angle of the stand, an image sensing performed from an upward incline by reason of compactness of the device and the like, and in this case document inclination correction is required similar to the modes of the previously described embodiments. In this case also the amount of inclination of the document relative to the image sensing unit may be determined beforehand by the construction of the stand, such that the document inclination may be a fixed value which is stored in memory.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. An image processing system comprising:
an image acquisition unit for acquiring a plurality of segment images by segment image sensing on a plurality of image sensing directions of a surface comprising the image sensing target when the image sensing device is stationary in a fixed standard direction;
a document inclination acquisition unit for acquiring the inclination of a surface comprising the image sensing target relative to the standard direction; and
a correction unit for correcting the plurality of obtained segment images in accordance with the inclination of the surface of the image sensing target and the inclination in the image sensing direction relative to the standard direction.

2. The image processing system as recited in claim 1, wherein the image sensing device is a portable digital camera.

3. The image processing system as recited in claim 1, wherein the document inclination acquisition unit acquires the inclination by calculation using the distance to the image sensing target.

4. The image processing system as recited in claim 1, wherein the inclination in the image sensing direction is determined by the number of segments in the segmented image sensing.

5. The image processing system as recited in claim 1, wherein the correction by the correction unit eliminates distortion of the segment image generated by the inclination in the image sensing direction.

6. The image processing system as recited in claim 5, wherein the distortion of the respective segment images is eliminated based on the same standard as the correction.

7. The image processing system as recited in claim 5, wherein the respective segment images are corrected so as to have the same ratio of size of the corrected segment image relative to the size of the segmented and sensed surface.

8. The image processing system as recited in claim 1, wherein the respective segment images are corrected so as to render continuous the adjacent segment images.

9. The image processing system as recited in claim 1, further comprising a paste process unit for pasting together the paste points of the corrected segment images.

10. The image processing system as recited in claim 9, wherein the distortion of the segment images is corrected using standardized paste points.

11. An image processing system comprising:
an image acquisition unit for acquiring a plurality of segment images when sensing segments of an image sensing target surface by an image sensing device;
a document inclination acquisition unit for acquiring the inclination of a surface comprising the image sensing target relative to the standard direction of the image sensing device; and
a correction unit for eliminating distortion in the acquired segment images based on identical references and considering the inclination of the surface of the image sensing target.

12. The image processing system as recited in claim 11, wherein the segment images include a part of the same part of the sensed target image, and the references are included in the same part.

13. The image processing system as recited in claim 12, wherein the segment images from which distortion has been eliminated are images which appear as if the entirety of segment image is sensed at a distance from the image sensing device to part of the target image equivalent to the reference.

14. An image processing system comprising:
an image acquisition unit for acquiring a plurality of segment images by segment sensing the surface of the target image by an image sensing device;
a document inclination acquisition unit for acquiring the inclination of a surface comprising the image sensing target relative to the standard direction of the image sensing device; and
a correction unit for eliminating distortion in the acquired segment images so as to have the ratio of the size of the corrected segment image equal to the size of the surface of the segment sensed image sensing target and considering the inclination of the surface of the image sensing target.

15. The image processing system as recited in claim 14, wherein the segment images acquired by the image acquisition unit are images sensed in different image sensing directions relative to the standard direction.

16. The image processing system as recited in claim 15, wherein the image sensing direction is considered in the elimination of the distortion of the respective segment images.

17. An image sensing device comprising:
an image sensing unit for segment sensing of an image sensing target by the image sensing device;
mode selector for selecting one mode from among a plurality of modes including a first mode for sensing a flat surface;
multipoint measuring unit for measuring the distance to the image sensing target at a plurality of points;
a determination unit for determining whether or not an image sensing target is a flat surface based on the measurement results of the multipoint measuring unit; and
a calculation unit for calculating the inclination of the image sensing target based on the measurement result of the multipoint measuring unit when the first mode is selected, and the image sensing target is a flat surface.

18. The image sensing device as recited in claim 17, wherein the image sensing unit comprises:
a solid state image sensing element;
horizontal axis for rotating the solid state image sensing element in a horizontal direction; and
a vertical axis for rotating the solid state image sensing element in a vertical direction; and
wherein the image sensing unit senses segment images of the image sensing target by the solid state image sensing element in a plurality of image sensing direction via rotation of the horizontal axis and the vertical axis.

19. A computer program for making the computer to execute the processes of:
an acquisition of a plurality of segment images when segment image sensing of an image sensing target in a plurality of image sensing directions by the image sensing device;
an acquisition of the inclination of the surface of the image sensing target relative to the standard direction of the image sensing device; and
an elimination of the distortion of the acquired segment images in accordance with the acquired inclination of the surface of the image sensing target and the inclination of the image sensing direction relative to the standard direction.
